(19) United States
(12) Patent Application Publication
(10) Pub. No.: US 2014/0092248 A1
(43) Pub. Date: Apr. 3, 2014

(54) FRONT AID CAMERA

(71) Applicant: Wilbert Lee Clewis, Fort Worth, TX (US)

(72) Inventor: Wilbert Lee Clewis, Fort Worth, TX (US)

(21) Appl. No.: 13/633,593

(22) Filed: Oct. 2, 2012

(51) Int. Cl. H04N 5/225

(52) U.S. Cl. CPC H04N 5/2251
USPC 348/148

(57) ABSTRACT

A front aid camera license plate holder comprising of a camera combination, for the purposes of viewing traffic, maximizing vision, minimizing hazards and blind zones.

### TECHNICAL FIELD

This present invention relates to motor vehicles such as trucks, vans, suv's, delivery trucks, school buses and the like; and more specifically, this invention relates to a safety mechanism of viewing right and left traffic turns at dangerous intersections, and stop signs.

### BACKGROUND OF THE INVENTION

At a busy intersection or in a school zone, it may be difficult for a driver to determine if it is safe to make a right or left turn because of a truck, van, suv, or bus blocking their view. Driver cannot possibly see all angles, blind zones, and obstructed views from their vantage point in a vehicle.

A split-second decision may have a long-lasting consequence, as a collision may result in serious injury for the driver or passengers of both cars and the cars following them. As motorist approach dangerous intersections their view is often obscured by surrounding vehicles, road signs vegetation, buildings, fences, barriers, and the like.

Thus there is a need for an inexpensive camera that enhances a motorist view of traffic, to determine if there is approaching cyclist, hover round scooters, pedestrians, and the like.

### SUMMARY

The forgoing descriptions of specific embodiments of the present invention have been presented for the purpose of illustration and description. They are not intended to be exhausted or to limit the present invention to the precise forms disclosed, and obviously many modifications and vibrations are possible in the light of the above teaching.

The exemplary embodiment was chosen and described in order to explain the principles of the present invention and its practical application, to thereby enable others skilled in the art to best utilize the present invention and various embodiments with various modifications as are suited to the particular use contemplated.

### BRIEF DESCRIPTION OF THE DRAWINGS

The accompanying drawings, which are incorporated in and form a part of the specification, illustrate the embodiments of the present invention and, together with the description, serve to explain the principles of the invention.

FIG. 1 is a front perspective view of the license plate holder with cameras; and attached hood for camera protection;

FIG. 2 is a front view of the license plate holder with cameras; and attached hood for camera protection;

FIG. 3 is the side view of the license plate holder with cameras;

FIG. 4 is the top view of the license plate holder with cameras;

FIG. 5 is the rear view of the license plate holder with cameras; and attached hood for camera protection;

FIG. 6 is the bottom view of the present invention.

FIG. 7 shows an illustration of motor vehicle approaching a one way intersection having encountered a blind zone or obscured view.

### DETAIL DESCRIPTION

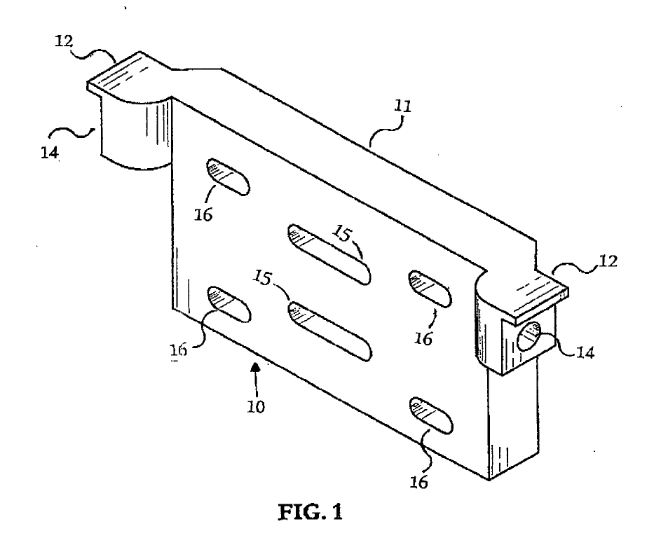

Referring to FIG. 1, front aid camera is a device 10 that increases a driver's line of sight on the road, which may increase safety on the roadways. The device 10 may be comprised of a license plate holder made from strong plastic that measure ⅝″ thick with one camera 14 connected to the upper left side of the license plate holder, while the other camera 14 is connected to the upper right side of the license plate holder. The aforementioned invention may be mounted to a motor vehicle's front bumper, by four security screws for ant-theft purposes.

Furthermore, a user's license plate may also be secured on top of it. The device 10 referring to FIG. 1, measure approximately 6¼″ high, 12¼″ wide. From the right camera 14 to the left camera 14 may measure approximately 20¼″ long and each side of the device 10 may include an adjustable pivot part so that the cameras 14 may move backward and forward as needed, pivot not shown in the drawings. The adjustable, CMOS or CCD cameras 14 may be waterproof with infrared night vision with a wide viewing angle of 90 degree.

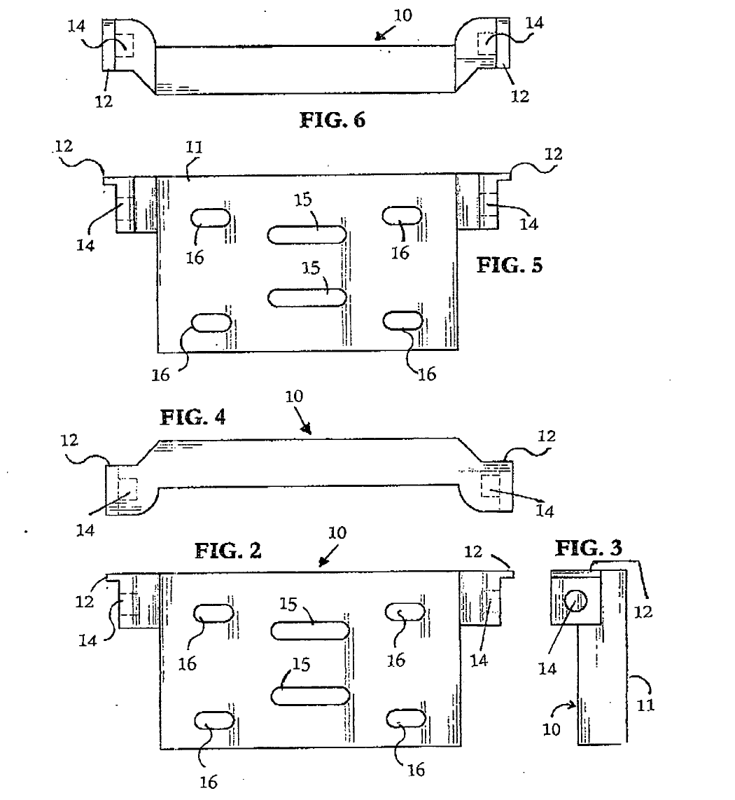

Referring to FIG. 2-6, One camera 14 may be connected to the upper left side of the license plate holder 10 camera, while the other side may be connected to the upper right side of the license plate 10 holder. The camera 10 housing referring to FIG. 2-5, may have a hood 12 attached to it, for protection from the rain, snow, and sunlight. The cameras 14 may get its power from through a wire connected to a vehicle's 12 volt power source. A user may watch the video from the cameras 10 on the interior of the vehicle through a monitor, or other portable media devices.

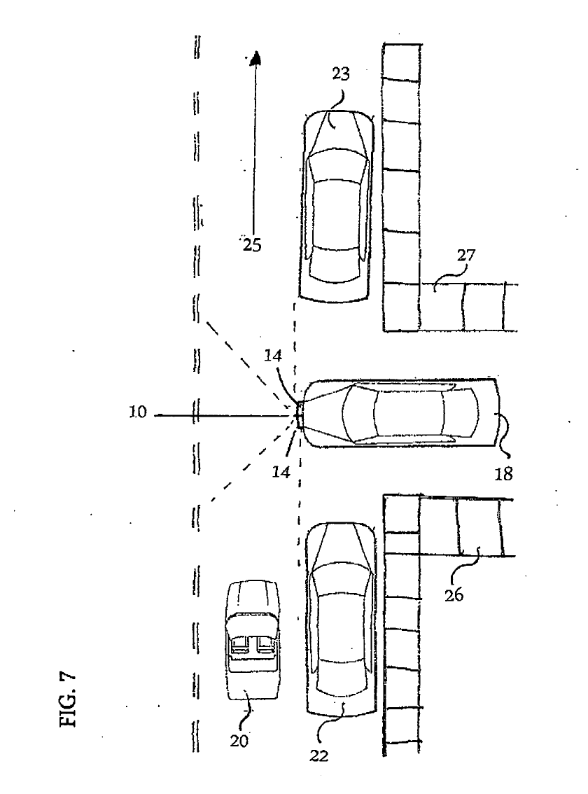

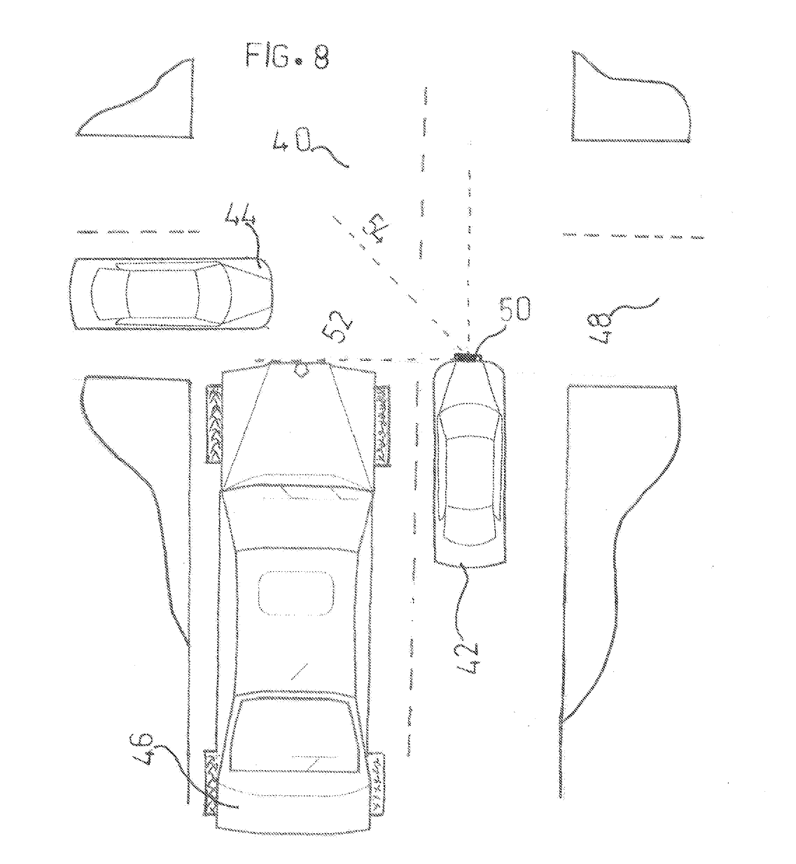

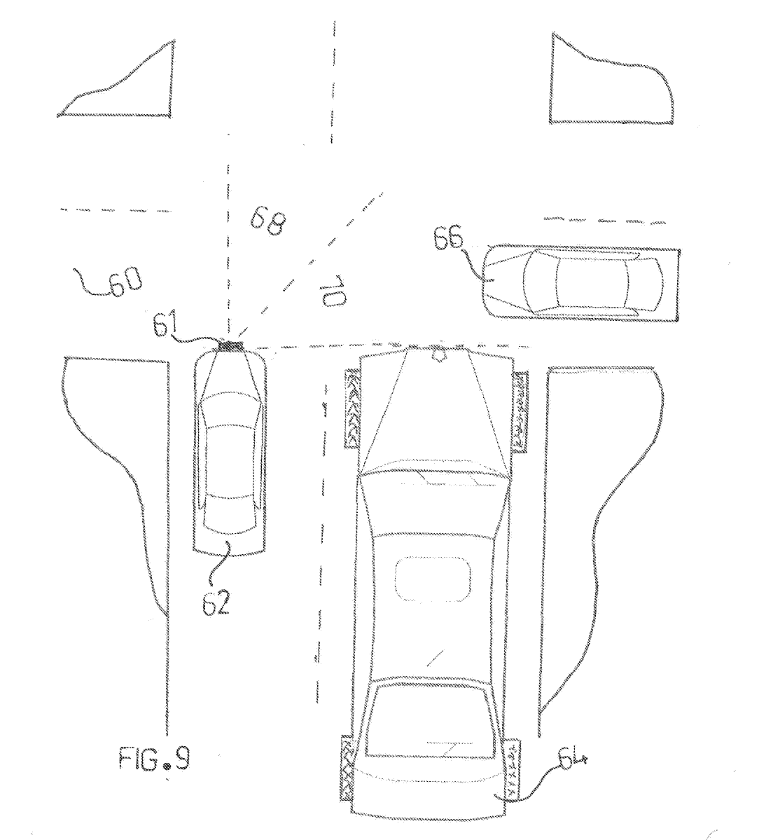

Referring to FIG. 7, vehicle 18 is shown approaching a one way intersection 25, both direction of the vehicle 18 are obscured by parked cars 22 and 23 and brick wall 26, 27. The driver in vehicle 18 has an advantage, vehicle 18 has the front aid camera 14 mounted on its front bumper 10, thus the driver in vehicle 18 has a 90 degree wide angle view at 28 and 29. By vehicle 18 having front aid camera at 10 attached to its front bumper, the driver in vehicle 18 has a clear view of vehicle 22 approaching in the blind spot.

1. A new design for a front license plate holder with a two camera combination comprising of;

2. one camera connected to upper right corner of the front license plate holder, and second camera is connected to the upper left corner of the license plate holder;

3. a partial hood for camera protection from rain, snow and sunlight;

4. of an adjustable pivotal camera for movement backward and forward.
